(19) United States
(12) Patent Application Publication
(10) Pub. No.: US 2018/0040264 A1
(43) Pub. Date: Feb. 8, 2018

(54) DEVICE FOR PRESENTING IMAGES IN A 3D FORMAT

(71) Applicant: Albert Mucciarone, Strongsville, OH (US)

(72) Inventor: Albert Mucciarone, Strongsville, OH (US)

(21) Appl. No.: 15/666,966

(22) Filed: Aug. 2, 2017

Related U.S. Application Data
(60) Provisional application No. 62/369,955, filed on Aug. 2, 2016.

(51) Int. Cl. G09F 7/08; G09F 19/12

(52) U.S. Cl. CPC G09F 7/08; G09F 19/12

(57) ABSTRACT

A three-dimensional framed display may include a frame member having polygonal inner and outer perimeter surfaces. The inner perimeter surface may define a plurality of ridges and troughs, wherein the troughs are identically dimensioned. The display may also include a plurality of channels being defined by the ridges and the troughs, wherein the plurality of channels are parallel to each other and collectively arranged in a fore to aft relation relative to the frame member. The plurality of channels may define a closed loop, wherein none of the plurality of channels breaks the outer perimeter surface. The channels may each hold a semitransparent image panel.

### I. BACKGROUND OF THE INVENTION

### A. Field of Invention

Embodiments of the invention generally relate to the field of picture frames for displaying hardcopy three-dimensional images.

### B. Description of the Related Art

Devices are known for displaying overlaid semitransparent images; however, existing devices require a user insert or remove images through slots in, for example, a frame. Others do not fully enclose the image panels, thereby subjecting them to edge-impact damage. Still others do not provide for interchangeable panels, thereby making it difficult for a user to create its own semitransparent image panels. What is needed is a device that fully encloses the edges of each image panel, and allows for interchangeability of panels.

Some embodiments of the present invention may provide one or more benefits or advantages over the prior art.

### II. SUMMARY OF THE INVENTION

Some embodiments may relate to a three-dimensional framed display. Displays may comprise a frame member having a polygonal outer perimeter. They may also include an outer perimeter surface, of the frame member, bounded by the polygonal outer perimeter. The display may further include an inner perimeter surface, of the frame member, being disposed within the outer perimeter surface. The inner perimeter surface may define a plurality of ridges and a plurality of troughs, wherein the troughs are identically dimensioned. The display may also include a plurality of channels being defined by the ridges and the troughs, wherein the plurality of channels are parallel to each other and collectively arranged in a fore to aft relation relative to the frame member. The plurality of channels may define a closed loop, and wherein none of the plurality of channels breaks the outer perimeter surface. The display may include a central opening bounded by the inner perimeter surface. The display may include a plurality of transparent panels each panel being received by a channel of the plurality of channels in a loose running fit, and retained by the ridges in a clearance fit. The display may further include a first variable opacity image disposed on a first transparent panel of the plurality of transparent panels. The first transparent panel may be in a foremost position, and the first variable opacity image may be covering a first two-dimensional region of the foremost transparent panel. A second variable opacity image may be disposed on a second transparent panel aft of the foremost transparent panel. The second variable opacity image may be covering a second two-dimensional region of the second transparent panel. The second two-dimensional region may be at least partially visible when the three-dimensional framed display is viewed from a front of the frame member.

In some embodiments each of the transparent panels are received about an entire perimeter of the transparent panel by the entire closed loop of the corresponding channel.

In some embodiments the frame member comprises a plurality of side members adjoined end-to-end to form the polygonal outer perimeter, the outer perimeter surface, and the inner perimeter surface.

In some embodiments the frame member has a geometric center coincident with a geometric center of the central opening.

In some embodiments the frame member has a geometric center that is not coincident with a geometric center of the central opening.

In some embodiments the plurality of ridges vary in height.

In some embodiments the inner perimeter surface defines a geometrically dissimilar polygonal perimeter relative to the outer perimeter surface.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof, wherein like reference numerals indicate like structure, and wherein:

FIG. 1A is a front elevation view of an embodiment;

FIG. 1B is a cross sectional view of the embodiment of FIG. 1A taken along line 1B-1B;

FIG. 2 is an exploded view of the embodiment of FIG. 1A; and

FIG. 3 is an illustration of an image blending effect enabled by embodiments of the invention.

### IV. DETAILED DESCRIPTION OF THE INVENTION

### A. Definitions

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

As used herein “adjoined” means to interlock such that the interlocking members are securely fastened to each other and thus have no relative motion, or have a degree of relative motion that does not negate the functionality of the interlocked members.

As used herein “bounded by” means to delimit in at least one dimension or degree of freedom.

As used herein “coincident” means occupying the same space.

As used herein for the purpose of describing channels the phrase “closed loop” means to sweep out a path where no end of the path is discernable, in the same sense that a circle or ring is a closed loop; however, a closed loop path is not limited to circles or rings, and may in fact take on polygonal forms.

As used herein “clearance fit” means any fit where the fitting members may slide freely relative to each other, and includes loose-running fits, free-running fits, close-running fits, and sliding fits. The term “clearance fit” is not intended to restrict the invention to a particular ISO or ANSI standards.

As used herein “variable opacity image” means that the visible spectrum opacity of a given image may vary in an X-Y plane of the image according to any optical density gradient pattern between 100% opacity to some lower limit up to including 0%. Moreover, opacity need not be constant over the visible spectrum. Accordingly, some light frequencies may be passed more efficiently than others, thus imparting color.

As used herein the term “perimeter” taken by itself refers to an abstract measure, and is not intended to denominate a structure. However, “perimeter” may be used as a descriptor of a structural component and thus may be part of a phrase denominating a structure. For example, the term “outer perimeter” indicates an abstract measure herein, while “outer perimeter surface” denominates a structural element characterized by an outer perimeter.

As used herein the term “geometrically similar” is intended to have its ordinary mathematical meaning indicating identical shapes that may differ only in size. Conversely, the meaning of “geometrically dissimilar” is intended to indicate shapes that are not identical without regard to size.

### B. Discussion

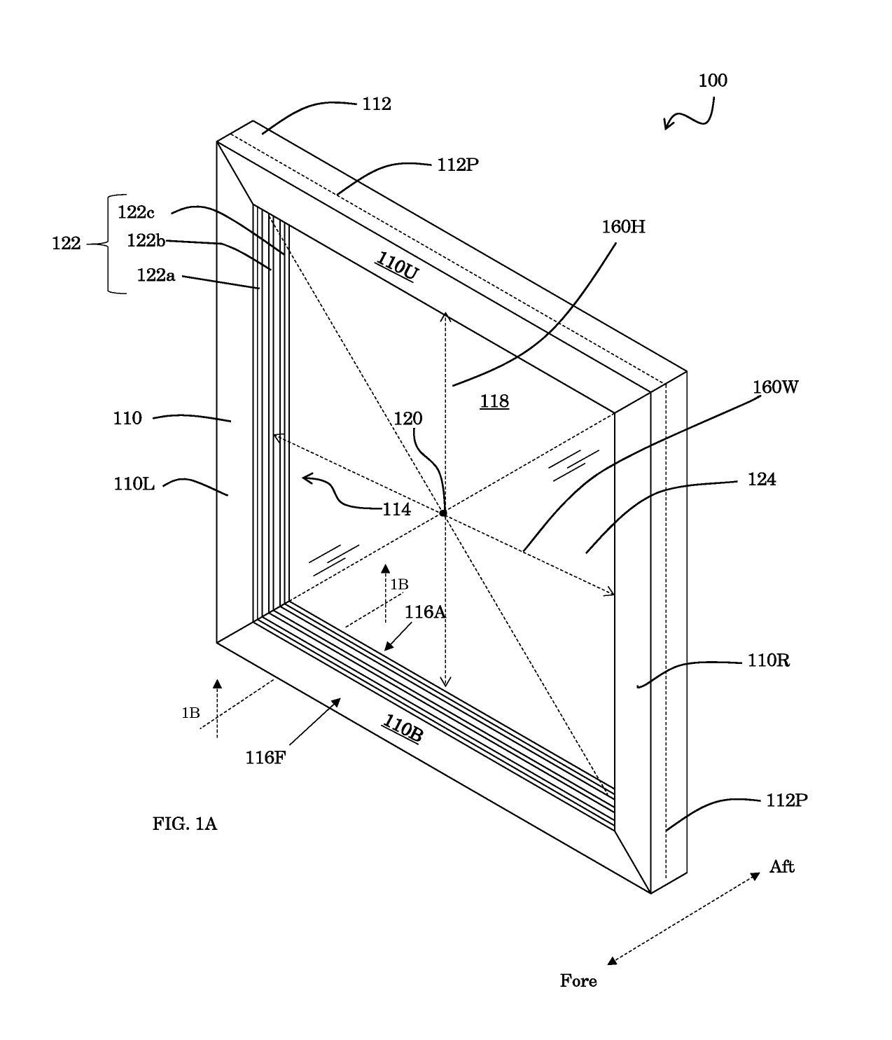

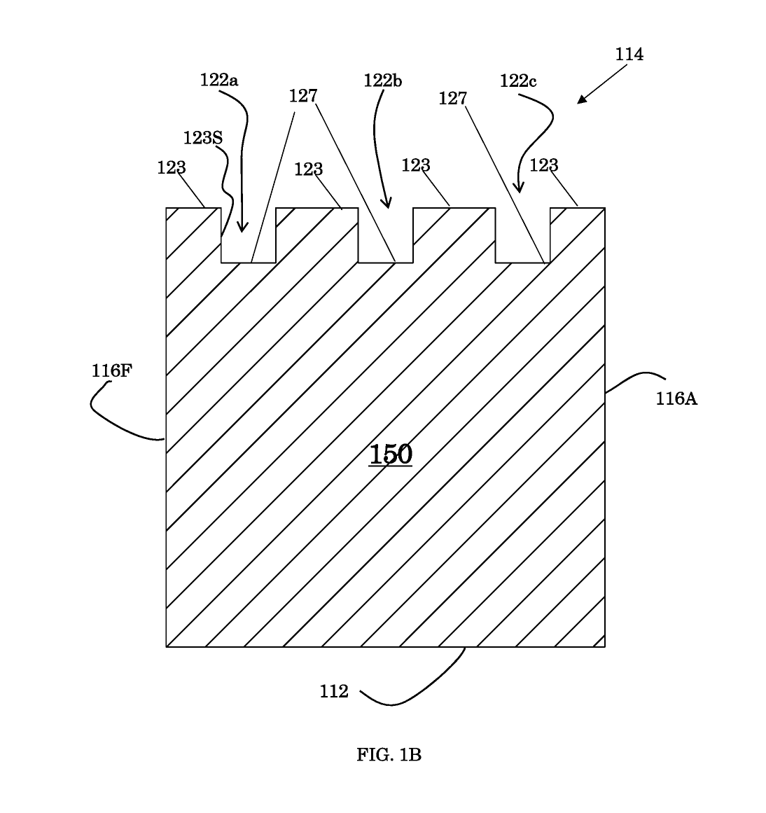

Referring now to the drawings wherein the showings are for purposes of illustrating embodiments of the invention only and not for purposes of limiting the same, FIG. 1A is an overall view of an embodiment showing a three-dimensional framed display 100. The display 100 includes a frame member 110, which includes an upper side member 110U, a bottom side member 110B, a left side member 110L, and a right side member 110R. The side members 110U, 110B, 110L, and 110R are adjoined end-to-end to form the rectangular frame member 110. The frame member 110 as drawn defines a polygonal outer perimeter 112P, or more specifically a rectangular outer perimeter 112P as indicated by the dashed line 112P in FIG. 1A. As used herein, the term “outer perimeter” indicates the gross form or shape defined by the frame member 110 outermost from a central point 120.

Furthermore, the frame member 110 has an outer perimeter surface 112. The outer perimeter surface 112 is an outermost boundary surface of the frame member 110 from a central point 120, and is thus bounded by the outer perimeter 112P of the frame member 110. Similarly, the frame member 110 also has an inner perimeter surface 114 which is an inner-most boundary of the frame member 110 relative to a central point 120, and is thus bounded by an inner perimeter(s) of the frame member 110. In the illustrated embodiment 100, the inner and outer perimeter surfaces 112, 114 are parallel to each other; however, this is principally for convenience in illustration rather than functionality. The skilled artisan will readily appreciate that the inner and outer surfaces 112, 114 need not be parallel or geometrically similar; however, the inner perimeter surface 114 is within or encompassed by the outer perimeter surface 112.

The embodiment 100 of FIG. 1A further includes a fore surface 116F and an aft surface 116A. The frame member 110 having a volume bounded by fore, aft, inner, and outer surfaces 116F, 116A, 114, 112 necessarily has not only surface, but also interior regions 150 as shown in FIG. 1B. As used herein, the term “interior” refers to the closed space bounded by one or more surfaces, and particularly the material occupying such space.

The inner perimeter surface 114 comprises a plurality of channels collectively indicated by reference character 122, and individually by 122a, 122b, and 122c. The channels 122 are recesses in, or recessions from, the inner perimeter surface 114 in to the frame interior 150, for example and without limitation, by milling. The channels 122 are defined by a plurality of ridges 123 and troughs 127.

Thus, the inner perimeter surface 114 can be said to define the channels and/or the plurality of ridges 123 and troughs 127. Each of the troughs 127 are identically dimensioned, so that panels 124 are interchangeable between channels 122a, 122b, and 122c. By “identically dimensioned” it is contemplated that the troughs are so dimensioned as to accommodate panels 124 having the same maximum length, width, and thickness. Accordingly, each channel 122 defines a central opening 118 having the same height 160H and the same width 160W as measured between opposing troughs. Thus, each embodiment has a plurality of central openings equal in number to the number of channels. Notably, the ridges 123 need not be identically dimensioned for purpose of interchangeability, and instead may vary in their height, i.e. the height of the sidewall 123S, as measured from the troughs 127 creating variations in the inner perimeter surface 114. Thus, the inner perimeter surface 114 may be geometrically dissimilar to the outer perimeter surface 112 while maintaining interchangeability of panels 124. For purposes of describing and claiming the invention, the sidewalls 123S are regarded as a component of the ridges 123 and not as a component of the troughs 127.

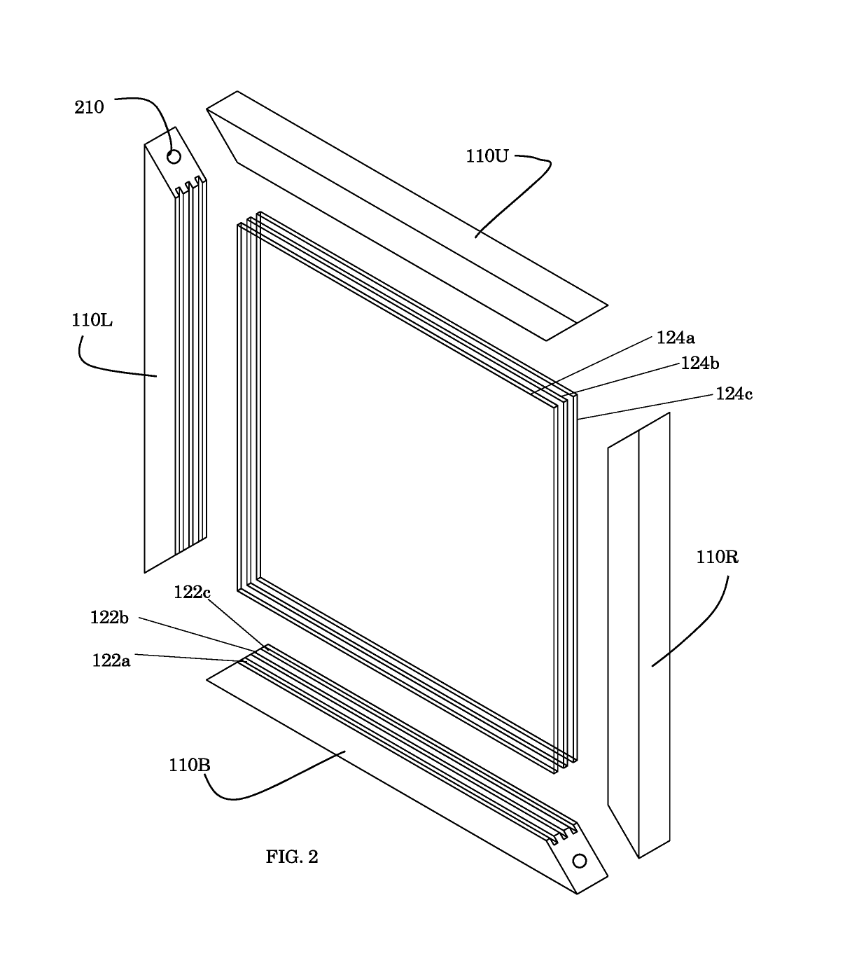

As shown in FIG. 1A, the channels 122a, 122b, 122c follow parallel closed-loop paths around the entire inner perimeter of the frame member 110 and are arranged in a fore to aft spacing in the inner perimeter surface 114 relative to the frame member 110. Thus, panels 124 may be stacked within the frame member 110 as shown in FIG. 1A and FIG. 2 within the display 100 so that a person viewing the display from the front will perceive a composite image. Moreover, the edges of each panel 124 engage an entire channel 122 throughout its entire closed-loop path, thereby supporting and protecting the entire perimeter of the panel 124. This guards against edge impact, and also has a stabilizing effect preventing the panels 124 from flexing.

With continuing reference to FIG. 1A, the frame member 110 defines a central opening 118 bounded by the inner perimeter surface 114. The frame member 110 of the present embodiment 100 is shown having a geometric center 120 coincident with the geometric center of the central opening 118. This symmetry is not a requirement of the invention, but merely reflects the geometry of the present embodiment.

While the channels 122a, 122b, 122c are recessed into the frame interior 150, no channel breaks through to the outer perimeter surface 112, and the channels 122a, 122b, 122c each define a generally rectangular cross section (see FIG. 1B) having vertical sidewalls 123S and horizontal ridges 123 and troughs 127. Accordingly, the frame member 110 is adapted to receive a transparent panel 124 in each channel 122a, 122b, 122c. Moreover, the channels 122 are so dimensioned as to receive the panels 124 in a clearance fit such as, without limitation, a loose running fit, which is advantageous for easy manual assembly of the device 100. For instance, a frame member 110 may be partially assembled by adjoining three of four sides 110L, 110B, 110R, manually sliding the panels 124 into place, and adjoining the fourth side 110U. In such embodiments, a clearance fit provides ease of assembly.

In some embodiments, the device 100 may be provided to end users partially assembled so that the end user may insert its own panels 124. Such embodiments may include pre-fitted structure for the end user to easily adjoin the fourth side with, for instance, a rod-and-hole interference fit or other means commonly known in the art. A hole 210 for receiving a dowel rod is shown in FIG. 2. Moreover, the invention is not limited to embodiments having three channels 122 or three transparent panels 124. Embodiments may be readily scaled to include any number of channels and panels.

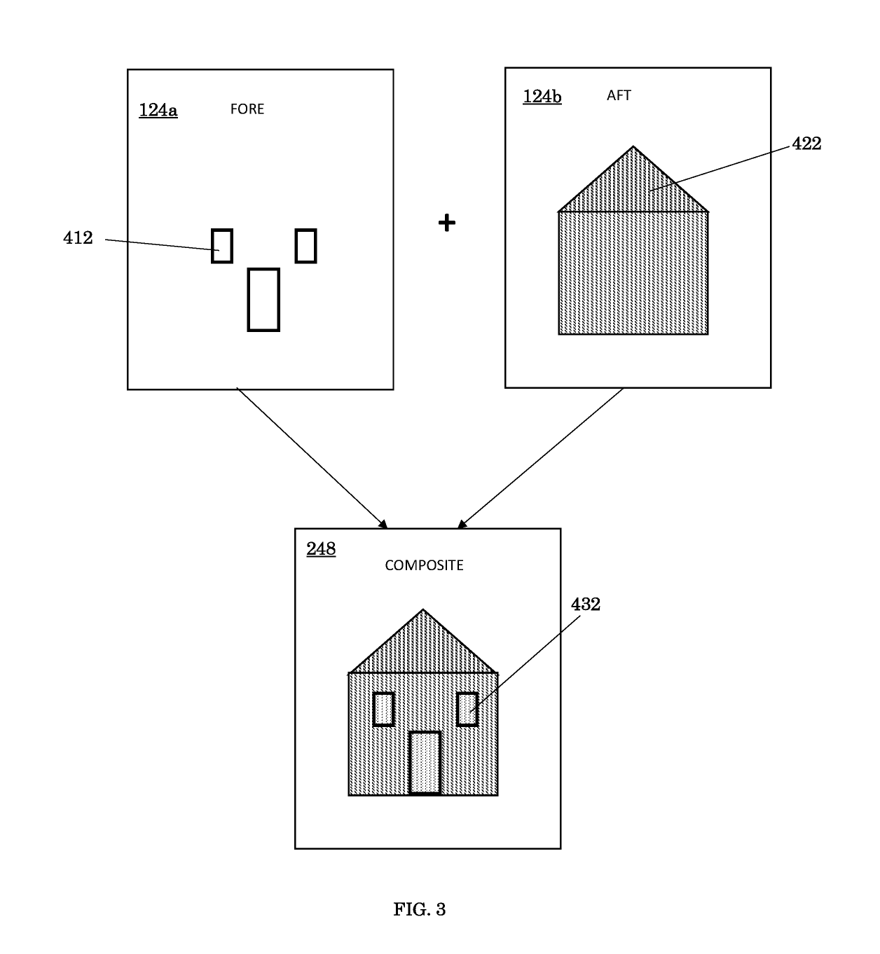

FIG. 3 illustrates how embodiments form a composite image. For simplicity, a two-panel example is described. As shown in FIG. 3 transparent panels 124a, 124b may each include different variable opacity images 412, 422. The example of FIG. 3 shows a fore panel 124a having three 50% opacity white rectangles with 100% opacity black outlining, and an aft panel 124b having a 100% opacity house shape with a black vertical line fill pattern. When the two panels 124a and 124b are overlaid they produce composite image 248. Reference character 432 indicates the region where 422 shows through 412. Accordingly, a depth effect or three-dimensional effect is produced as shown in FIG. 3.

Further, the variable opacity of the images may provide varying degrees of perceived blending of the stacked images. Thus, a viewer may see through a partially transparent front image to simultaneously view one or more images behind it. If each of the stacked images is partially transparent along the same line of sight then the image perceived by an observer will be a composite image. In some embodiment the variable opacity of images may be used to produce lighting effects by permitting predetermined amounts of light transmission through an image.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

I/we claim:

1. A three-dimensional framed display (100), comprising:
a frame member (110) having a polygonal outer perimeter (112P);
an outer perimeter surface (112), of the frame member (110), bounded by the polygonal outer perimeter (112P);
an inner perimeter surface (114), of the frame member (110), being disposed within the outer perimeter surface (112), the inner perimeter surface defining a plurality of ridges (123) and a plurality of troughs (127), wherein the troughs (127) are identically dimensioned;
a plurality of channels (122) being defined by the ridges (123) and the troughs (127), wherein the plurality of channels (122) are parallel to each other and collectively arranged in a fore to aft relation relative to the frame member (110), wherein each of the plurality of channels (122) defines a closed loop, and wherein none of the plurality of channels (122) breaks the outer perimeter surface (112);
a plurality of central openings (118) each bounded by a trough of the plurality of troughs (127);
a plurality of transparent panels (124) each disposed in a central opening (118) of the plurality of central openings (118), wherein each of the transparent panels (124) is received by a corresponding channel of the plurality of channels (122) in a loose running fit, and retained by the ridges (123) in a clearance fit;
a first variable opacity image disposed on a first transparent panel (124) of the plurality of transparent panels (124), the first transparent panel (124) being in a foremost position, and the first variable opacity image covering a first two-dimensional region of the foremost transparent panel (124); and
a second variable opacity image disposed on a second transparent panel (124) aft of the foremost transparent panel (124), the second variable opacity image covering a second two-dimensional region of the second transparent panel (124), wherein
the second two-dimensional region is at least partially visible when the three-dimensional framed display is viewed from a front of the frame member (110).

2. The display of claim 1, wherein each of the transparent panels (124) are received about an entire perimeter of the transparent panel by the entire closed loop of the corresponding channel.

3. The display of claim 2, wherein the frame member (110) comprises a plurality of side members adjoined end-to-end to form the polygonal outer perimeter (112P), the outer perimeter surface (112), and the inner perimeter surface (114).

4. The display of claim 1, wherein the frame member (110) has a geometric center (120) coincident with a geometric center of the plurality of central openings (118).

5. The display of claim 1, wherein the frame member (110) has a geometric center (120) that is not coincident with a geometric center of the plurality of central openings (118).

6. The display of claim 1, wherein one or more of the plurality of ridges (123) vary in height.

7. The display of claim 1, wherein the inner perimeter surface (114) defines a geometrically dissimilar polygonal perimeter relative to the outer perimeter surface (112).
